(19) United States
(12) Patent Application Publication
(10) Pub. No.: US 2026/0229942 A1
(43) Pub. Date: Aug. 6, 2026

(54) ROTOR FOR AN ELECTRIC MOTOR, METHOD FOR PRODUCING SAME, AND ELECTRIC MOTOR

(71) Applicant: Schunk Kohlenstofftechnik GmbH, Heuchelheim (DE)

(72) Inventor: Tim Krooss, Lich (DE)

(21) Appl. No.: 19/147,869

(22) PCT Filed: Jan. 13, 2023
(86) PCT No.: PCT/EP2023/050696

§ 371 Date: Jul. 14, 2025

(51) Int. Cl. H02K 1/30; H02K 1/2795; H02K 15/035

(52) U.S. Cl. CPC H02K 1/30; H02K 1/2795; H02K 15/035

(57) ABSTRACT

The invention relates to a rotor (10) for an electric motor, in particular a brushless axial flux motor or a brushless radial flux motor, and a method for its production, the rotor comprising a rotor body and magnets (22) attached to the rotor body. The rotor body has at least one rotor hub (17) for being coupled to a motor shaft of the electric motor and at least two rotor elements (12) attached to the rotor hub, the rotor elements forming struts (13, 14) extending from the rotor hub in the shape of a star in a radial direction of the rotor, the rotor elements being made of a fiber composite material, the magnets being attached to the rotor elements.

The invention relates to a rotor for an electric motor, a method for its production, and an electric motor, in particular a brushless axial flux motor or a brushless radial flux motor, the rotor comprising a rotor body and magnets attached to the rotor body.

A rotor of this kind is sufficiently known from the state of the art and is used in different designs for various applications. For example, a rotor of an electric motor realized as a brushless axial flux motor or disk motor is configured in such a manner that permanent magnets of the rotor are located on an axial side of the rotor or of a disk-shaped rotor body of the rotor. The rotor body, which is also referred to as a disk rotor, is essentially configured in such a manner that a diameter of the rotor body is greater than a length of the rotor body. In this case, a stator of the electric motor is typically positioned opposite the axial side of the rotor, on which the permanent magnets are disposed. The stator has coils, which are then disposed opposite the axial side of the rotor. This brushless design of the electric motor is advantageous in that no brushes for supplying the rotor with power are required and the electric motor can therefore be operated very reliably. A magnetic field formed by the permanent magnets of the axial flux motor runs parallel to an axis of rotation of the rotor. By contrast, a corresponding magnetic field of an electric motor realized as a radial flux motor is perpendicular to an axis of rotation of a rotor of the electric motor.

In the case of the rotor known from the prior art, the rotor body is usually made of a metallic material, in particular an aluminum alloy or a high-strength steel. The rotor body can then basically be manufactured in a cost-effective manner. In addition, the rotor body is then easy to machine, so that receptacles for the magnets can be formed by milling pockets in the rotor body.

However, it has been found to be disadvantageous that the rotor has a comparatively high mass due to a comparatively high density of the metallic material usually used to form the rotor body, which in turn leads to a comparatively high mass moment of inertia of the rotor. In addition, at high rotor speeds, for example at up to 40,000 to 50,000 revolutions per minute, depending on the metal material used, centrifugal forces acting on the magnets held in the receptacles regularly cause plastic deformation of the rotor body, which damages the rotor body, as the magnets are pressed against a radial side of the respective receptacles as a result of the centrifugal forces. Hence, an operating speed of the rotor and thus a power of an electric motor comprising the rotor is limited. In addition, the use of the metallic material causes eddy current losses, which further reduce the power of the electric motor.

Therefore, the object of the present invention is to propose a rotor for an electric motor, an electric motor, and a method for producing a rotor which enable improved operation of an electric motor.

This object is attained by a rotor having the features of claim 1, an electric motor having the features of claim 12, and a method for producing a rotor having the features of claim 13.

The rotor according to the invention for an electric motor, in particular a brushless axial flux motor or a brushless radial flux motor, comprises a rotor body and magnets attached to the rotor body, wherein the rotor body has at least one rotor hub for being coupled to a motor shaft of the electric motor and at least two rotor elements attached to the rotor hub, the rotor elements forming struts extending from the rotor hub in the shape of a star in a radial direction of the rotor, the rotor elements being made of a fiber composite material, the magnets being attached to the rotor elements.

The rotor according to the invention is intended for an electric motor, which can in particular be a brushless axial flux motor or disk motor or a brushless radial flux motor, and comprises a rotor body and magnets, i.e., permanent magnets, which are attached to the rotor body.

According to the invention, the rotor body has a rotor hub configured to be connected or coupled to a motor shaft of the electric motor. The rotor hub can be designed such that the motor shaft of the electric motor can be passed through the rotor body or attached with one end to the rotor body, for example by means of a flange.

According to the invention, the rotor body has at least two or a plurality of rotor elements, which are preferably of the same design, the rotor elements forming star-shaped or spoke-like struts extending from the rotor hub in a radial direction of the rotor, i.e., perpendicular to an axial direction of the rotor or an axis of rotation of the rotor. The magnets are attached to the rotor elements; in particular, the magnets can be attached to the struts and/or to (radial) outer portions of the rotor elements. The rotor elements are made of a fiber composite material, preferably by winding. This has the advantage that the rotor body or the rotor elements can be of a lightweight construction and thus have a comparatively low mass or a comparatively low mass moment of inertia, while also offering comparatively high mechanical stability against plastic deformation. The rotor can therefore be operated, in particular without damage, even at high rotor speeds of at least 40,000 to 50,000 revolutions per minute, which enables operation of an electric motor comprising the rotor with comparatively increased power. In addition, eddy current losses can be reduced, which further increases the power of the electric motor. Overall, the rotor thus enables improved operation of the electric motor.

The rotor elements can be made of glass fibers, aramid fibers, or carbon fibers and a plastic resin. The plastic resin can form a matrix of the fiber composite material and be cured. The plastic resin can be a thermosetting or thermoplastic resin, for example epoxy resin. The rotor elements can then be manufactured particularly cost-effectively and easily. A thermoplastic matrix enables the rotor elements to be joined without additional adhesives, for example by welding, such as ultrasonic welding. Compared to a thermosetting matrix, the thermoplastic matrix has a longer shelf life, is non-toxic, and is easily recyclable.

Alternatively, the rotor elements can be made of carbon-fiber-reinforced carbon. The rotor elements can then also be manufactured from organic fibers and an organic matrix by pyrolysis. Rotor elements designed in this way are also mechanically highly resilient at high temperatures.

The rotor elements can have receptacles for holding the magnets. The receptacles can each be formed in a space between the struts, and the space can be designed as a passage in the axial direction. The rotor elements can each form two struts, which can be spaced apart from each other in such a manner that the space can be formed between the two struts. This space can be designed in such a manner that there is sufficient room for one or more magnets. The space can be designed in such a manner that it can be filled only partially or completely by a magnet. In principle, the receptacles can be designed in such a manner that the magnets can each be flush with at least one axial side of the rotor.

The magnets can each be designed as a preferably wedge-shaped plate. The magnets can then be easily manufactured from a plate-shaped material blank. The plate can be attached to one of the rotor elements in such a manner that a normal of a flat surface of the plate extended in relation to a thickness of the plate can be aligned parallel to the axial direction of the rotor or the axis of rotation of the rotor. The plate can, for example, be designed in the form of a parallelogram with side edges inclined relative to each other. A base line connecting the side edges can be straight or have a radius, such as a radius adapted to a radius of the rotor. In this manner, magnets with a comparatively large mass can be positioned close to a circumference of the rotor. The plate can also be attached to one of the rotor elements in such a manner that a normal of a flat surface of the plate extended in relation to a thickness of the plate can be aligned parallel to the radial direction of the rotor. The plate can abut on an outer portion of the rotor element from the inside with the surface or be attached to the outer portion from the inside.

The rotor elements can be disposed on the rotor hub in such a manner that struts of adjacent rotor elements can be at least partially, preferably completely, abut one another so that a strut of a rotor element can at least partially, preferably completely, abut on a strut of a rotor element disposed immediately adjacent to said rotor element on the rotor hub. Two struts that abut one another, which can be attached, in particular bonded, to each other in a complementary manner, can then form a double strut in each case, which can exhibit increased mechanical stability. It is also conceivable for individual struts to have a lower material thickness, which saves fiber composite material. Alternatively, the rotor elements can also be disposed on the rotor hub in such a manner that the struts of adjacent rotor elements can be spaced apart from each other.

Furthermore, the rotor elements can together form a ring in cross section. The rotor elements can be designed in the shape of circle segments in cross section, meaning the outer portions of the rotor elements, which are circular arc-shaped in cross section, together can form the ring or a circular ring. The rotor elements can then be joined particularly easily by means of an reinforcement ring or reinforcement cylinder of the rotor body, which may be provided optionally, wherein the reinforcement ring or reinforcement cylinder can establish a rotationally symmetrical force fit. In principle, however, the cross-sectional shape of the rotor elements can be arbitrary or selected as appropriate. In particular, the rotor elements can also be polygonal, in particular rectangular, in cross section. The outer portions of the rotor elements, which can connect the struts on the radial outside, can be straight and/or curved in cross section. The radially extending struts of the rotor elements can be straight in cross section, but can also have straight and curved portions.

The rotor or rotor body can be disk-shaped or cylindrical. The rotor can then be designed for use with an axial flux motor or disk motor or a radial flux motor. The rotor can be designed to be disk-shaped or cylindrical by making the rotor elements comparatively short or long in the axial direction. If the rotor is disk-shaped, the rotor body can have one rotor hub, whereas a cylindrical rotor can advantageously have at least two rotor hubs, each of which can be flush with one of the two axial sides of the rotor.

The rotor hub can be made of a fiber composite material or a metal. If the rotor hub is made of a fiber composite material, the rotor body can then be designed entirely in a lightweight construction. In particular, the rotor hub can be made of the same fiber composite material as the rotor elements. Consequently, it is possible for the entire rotor body to be made of this fiber composite material. The rotor body can also be manufactured particularly easily since the fiber composite material of the rotor hub and the rotor elements can be cured in a single step. The rotor elements can be bonded to the rotor hub and, if applicable, to each other via the fiber composite material. The rotor hub can also be formed by injection molding using fiber reinforcement. Alternatively, the rotor hub can be made of a metal, in particular a metal alloy, such as an aluminum alloy or a steel alloy. In this case, the rotor hub can be produced by machining, for example by milling, and can also be easily further processed by machining.

Furthermore, the rotor hub can be formed in one piece or in several parts. A one-piece rotor hub is particularly easy to manufacture. If the rotor hub composed of several parts, the individual parts can be welded or screwed together, for example. Furthermore, the rotor hub can have a round or angular geometry or cross-sectional shape.

The rotor hub can have grooves for attaching the rotor elements, which can be used to attach the rotor elements to the rotor hub in a form-fitting manner. If the rotor hub is made of metal, the grooves can be easily formed in the rotor hub by machining, e.g., milling, the rotor hub.

Furthermore, the rotor body can have a circumferential reinforcement attached to the rotor elements, the reinforcement preferably being made of a fiber composite material, such that the struts can extend in the shape of a star between the rotor hub and the reinforcement. The reinforcement of the rotor body can additionally prevent any undesirable deformation of the rotor body. The reinforcement can be attached to the rotor elements by bonding, for example by gluing, and/or by a force fit, for example by a press fit. If the reinforcement is made of the same fiber composite material as the rotor elements, the reinforcement can also be connected to the rotor elements by simultaneous curing of the fiber composite material of the reinforcement and the fiber composite material of the rotor elements. Advantageously, the reinforcement can be an reinforcement ring or reinforcement cylinder which encloses or surrounds the rotor elements and which can establish a rotationally symmetrical force fit and thereby join the rotor elements.

Furthermore, the rotor body can have an outer ring such that the struts extend in the shape of a star between the rotor hub and the outer ring.

Advantageously, the outer ring can further reinforce or compact the rotor body. The outer ring can be placed on the rotor elements or the reinforcement. The outer ring can be formed by winding in the form of an outer winding, for the formation of which all conventional winding methods are conceivable. A thickness or width of the outer winding can vary and take on different shapes. Alternatively, the (finished) outer ring can be force-fitted and/or bonded and/or form-fitted to the rotor body. The outer ring can be designed with a preload. The preload can be established during winding, for example. The preload can increase the strength of the rotor body. The rotor elements can connect the outer ring and the rotor hub.

Other advantageous embodiments of the rotor are apparent from the feature descriptions of the claims dependent on process claim 13.

The electric motor according to the invention, in particular a brushless axial flux motor or a brushless radial flux motor, has a rotor according to the invention and a stator.

In the method according to the invention for producing a rotor for an electric motor, in particular a brushless axial flux motor or a brushless radial flux motor, magnets of the rotor are attached to a rotor body of the rotor, wherein at least two rotor elements of the rotor body are attached to at least one rotor hub of the rotor body for being coupled to a motor shaft of the electric motor, the rotor elements forming struts extending from the rotor hub in the shape of a star in a radial direction of the rotor, the rotor elements being made of a fiber composite material, the magnets being attached to the rotor elements.

Regarding the advantageous effects of the method, reference is made to the description of advantages of the rotor according to the invention.

The rotor elements can be formed particularly simply if the rotor elements are formed by forming a hollow winding profile by impregnating and winding a fiber material or by winding a semi-finished fiber matrix product onto a circumference of a winding core, which can be part of a winding device, and cutting the winding profile into the rotor elements. First, a winding profile with a comparatively large length, e.g., 2000 mm to 5000 mm or more, can be formed, which can then be cut or divided into a plurality of rotor elements. This enables cost-effective production of the rotor elements. A geometry or a cross-sectional shape of the rotor elements can be easily determined by a geometry or a cross-sectional shape of the winding core. Furthermore, a material thickness or wall thickness or thickness of the rotor elements can be easily determined by a number of winding layers or windings disposed one above the other in the winding profile. In particular, wet winding or prepreg winding or tow preg winding are options for manufacturing the winding profile. The winding profile can also be manufactured by thermoplastic or thermosetting tape laying. The fiber material can be a roving or a fiber tape. The winding can be carried out in such a manner that fibers of the fiber material or the semi-finished fiber matrix product can essentially be oriented in the radial direction in the rotor elements disposed on the rotor hub, in particular in the struts. However, a different fiber orientation is also conceivable, for example if the rotor is to be designed to absorb axial loads. In principle, a winding angle can be selected in such a manner that the fibers in the rotor elements disposed on the rotor hub can essentially be oriented at an angle of 0° to 90° to the axis of rotation, in particular in the struts. Subsequently, the winding profile is cut or divided into the rotor elements, in which process a depth of the rotor elements or a dimension of the rotor elements in the axial direction can be easily adapted to a size of the magnets and/or to an electric motor for which the rotor is to be used by selecting a distance between cutting lines on the winding profile at which the cutting is to take place.

The winding profile can be removed from the winding core before being cut into the rotor elements. A continuous process is also conceivable, in which winding, removal, and/or cutting can be carried out in parallel.

For this purpose, the winding core can have a special guide and the winding device can comprise a kind of “flying” cutting device or cutting wheel.

The fiber composite material can be cured before cutting or after cutting. Curing can also take place after the rotor elements have been attached to the rotor hub.

The rotor elements can be form-fitted and/or force-fitted and/or bonded to the rotor hub. Attachment portions of the rotor elements intended for attachment to the rotor hub, which can be straight, curved or pointed in cross section, can be attached to the rotor hub. The attachment portions can engage grooves of the rotor hub in a form fit and be secured in the grooves by a press fit. Furthermore, the rotor elements can be glued to the rotor hub or thermoplastically welded to the rotor hub, for example by ultrasonic welding. If the rotor hub is also made of the fiber composite material, the rotor hub can be cured together with the rotor elements. This also enables a bonded connection between the rotor elements and the rotor hub.

Furthermore, the rotor elements can be form-fitted and/or force-fitted and/or bonded to each other. In particular, the struts of adjacent rotor elements can be glued to each other in such a manner that these struts can form particularly stable double struts. Furthermore, it is also conceivable for the joined components, i.e., the rotor hub and the rotor elements, to be back-injected, for example with a fiber-reinforced polymer. Reinforcements produced in this manner can be provided in particular in the area of the receptacles for the magnets. The back injection also allows the rotor elements to be connected or attached to one another.

Furthermore, the magnets can be form-fitted and/or force-fitted and/or bonded to the rotor elements. The magnets can be pressed into the receptacles or secured by injecting a polymer mass or an adhesive into the receptacles. The magnets can be attached to the rotor elements before or after the rotor elements are attached to the rotor hub. The magnets can be magnetized before or after they are attached to the rotor elements. This allows the sequence of manufacturing steps to be optimized.

Furthermore, a circumferential reinforcement of the rotor body can be attached to the rotor elements in such a manner that the struts extend in the shape of a star between the rotor hub and the reinforcement.

Furthermore, an outer ring of the rotor body can be formed by winding on the rotor body or attached to the rotor body in such a manner that the struts extend in the shape of a star between the rotor hub and the outer ring.

Other advantageous embodiments of the method are apparent from the feature descriptions of the claims dependent on device claim 1.

The invention is explained in more detail below with reference to the ac-companying drawings.

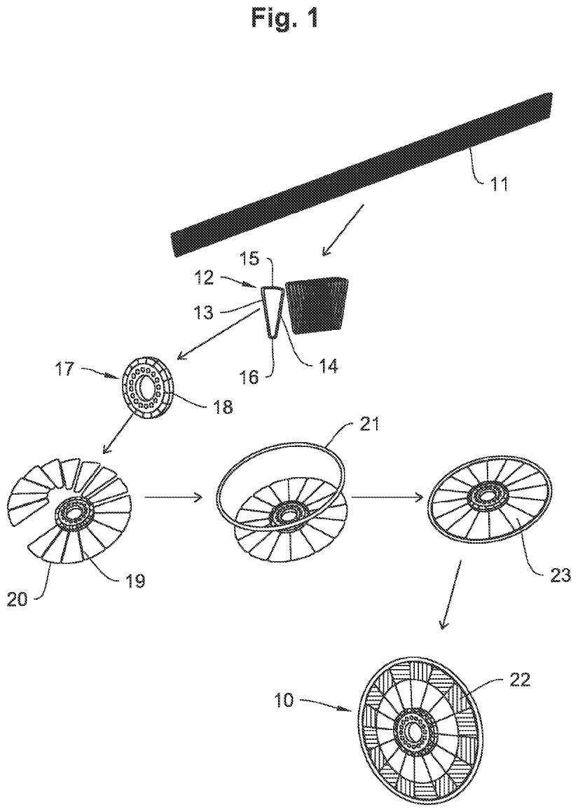

FIG. 1 shows a workflow of a method for producing a rotor in a first Embodiment;

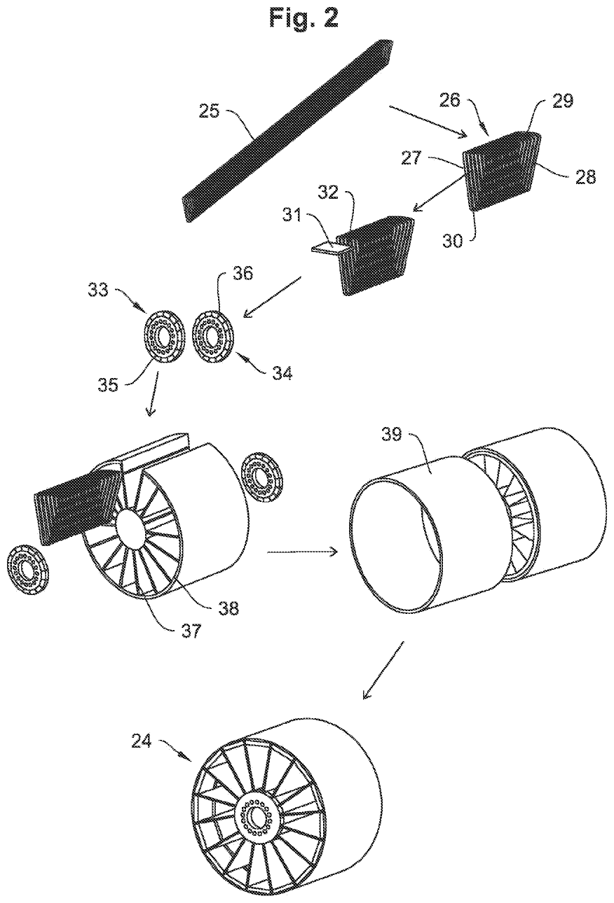

FIG. 2 shows a workflow of a method for producing a rotor in a second embodiment;

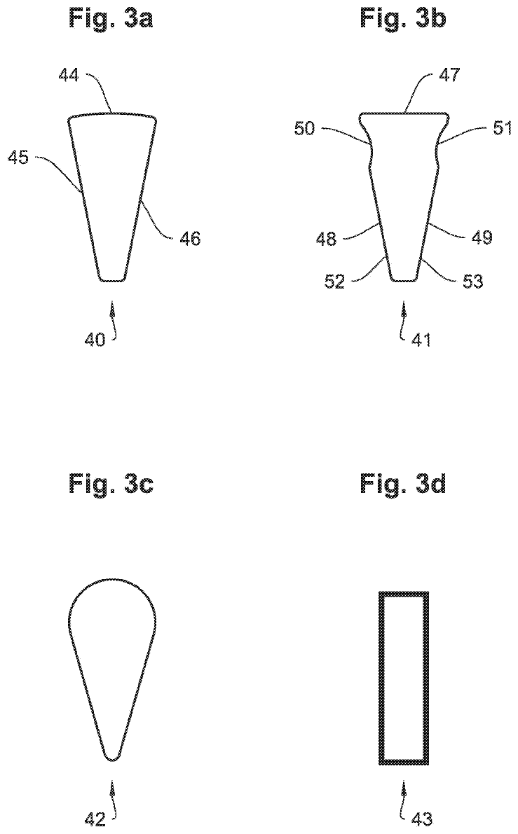

FIG. 3a is a sectional view of a rotor element in a first embodiment;

FIG. 3b is a sectional view of a rotor element in a second embodiment;

FIG. 3c is a sectional view of a rotor element in a third embodiment;

FIG. 3d is a sectional view of a rotor element in a fourth embodiment.

FIG. 1 shows a work workflow of a method for producing a disk-shaped rotor 10 for an axial flux motor (not shown). First, a hollow winding profile 11 is formed, from which identical rotor elements 12 are obtained by cutting. The rotor elements 12 are each circular segment-shaped in cross section and each form two struts 13, 14, an outer portion 15, and an attachment portion 16. Then, the rotor elements 12 are attached to a rotor hub 17, with the attachment portions 16 engaging grooves 18 of the rotor hub 17 in a form-fitting manner. The rotor elements 12 are disposed on the rotor hub 17 in such a manner that struts of adjacent rotor elements form double struts 19 by abutting one another in each case and the outer portions 15 together form a ring 20 in cross section. Next, a circumferential reinforcement 21 designed as an reinforcement ring is attached to the rotor elements 12 in such a manner that the struts 13, 14 extend in the shape of a star between the rotor hub 17 and the reinforcement 21. Magnets 22 are then attached to the rotor elements 12, with the magnets 22 being disposed in receptacles 23 of the rotor elements 12 formed as spaces between the struts 13, 14.

FIG. 2 shows a workflow of a method for producing a cylindrical rotor 24 for a radial flux motor (not shown). First, a hollow winding profile 25 is formed, from which identical rotor elements 26 are obtained by cutting. The rotor elements 26 are each circular segment-shaped in cross section and each form two struts 27, 28, an outer portion 29, and an attachment portion 30. Then, magnets 31 are attached to the rotor elements 26, with the magnets 31 being disposed in receptacles 32 of the rotor elements 26 formed as spaces between the struts 27, 28. The rotor elements 26 are then attached to two rotor hubs 33, 34, with the attachment portions 30 engaging grooves 35, 36 of the rotor hubs 33, 34 in a form-fitting manner. The rotor elements 26 are disposed on the rotor hubs 33, 34 in such a manner struts of adjacent rotor elements form double struts 37 by abutting one another in each case and the outer portions 29 together form a ring 38 in cross section. A circumferential reinforcement 39 designed as an reinforcement cylinder is then attached to the rotor elements 26 in such a manner that the struts 27, 28 extend in the shape of a star between the rotor hubs 33, 34 and the reinforcement 39.

FIGS. 3a to 3c show different embodiments of rotor elements 40, 41, 42, 43, each shown in cross section. The rotor element 40 shown in FIG. 3a has the shape of a circle segment in cross section, with the rotor element 40 forming a circular-arc-shaped outer portion 44 and two straight struts 45, 46 in cross section. The rotor element 41 shown in FIG. 3b forms a straight outer portion 47 and struts 48, 49, which each have a curved portion 50, 51 and a straight portion 52, 53, in cross section. The rotor element 42 shown in FIG. 3c has an elongated drop shape in cross section. Finally, the rotor element 43 shown in FIG. 3d has a rectangular shape in cross section.

1. A rotor (10, 24) for an electric motor the rotor comprising a rotor body and magnets (22, 31) attached to the rotor body, wherein the rotor body has at least one rotor hub (17, 33, 34) for being coupled to a motor shaft of the electric motor and at least two rotor elements (12, 26, 40, 41, 42, 43) attached to the rotor hub, the rotor elements forming struts (13, 14, 27, 28, 45, 46, 48, 49) extending from the rotor hub in the shape of a star in a radial direction of the rotor, the rotor elements being made of a fiber composite material, the magnets being attached to the rotor elements.

2. The rotor according to claim 1, wherein the rotor elements (12, 26, 40, 41, 42, 43) are made of glass fibers, aramid fibers or carbon fibers and a plastic resin.

3. The rotor according to claim 1, wherein the rotor elements (12, 26, 40, 41, 42, 43) are made of carbon-fiber-reinforced carbon.

4. The rotor according to claim 1, wherein the rotor elements (12, 26, 40, 41, 42, 43) have receptacles (23, 32) for holding the magnets (22, 31).

5. The rotor according to claim 1, wherein struts of adjacent rotor elements at least partially abut one another.

6. The rotor according to claim 1, wherein the rotor elements (12, 26) together form a ring (20, 38).

7. The rotor according to claim 1, wherein the rotor (10, 24) is disk-shaped or cylindrical.

8. The rotor according to claim 1, wherein the rotor hub (17, 33, 34) is made of a fiber composite material or a metal.

9. The rotor according to claim 1, wherein the rotor hub (17, 33, 34) has grooves (18, 35, 36) for attaching the rotor elements (12, 26, 40, 41, 42, 43).

10. The rotor according to claim 1, wherein the rotor body has a circumferential reinforcement (21, 39) attached to the rotor elements (12, 26, 40, 41, 42, 43) in such a manner that the struts (13, 14, 27, 28, 45, 46, 48, 49) extend in the shape of a star between the rotor hub (17, 33, 34) and the reinforcement.

11. The rotor according to claim 1, wherein the rotor body has an outer ring in such a manner that the struts (13, 14, 27, 28, 45, 46, 48, 49) extend in the shape of a star between the rotor hub (17, 33, 34) and the outer ring.

12. An electric motor comprising a rotor (10, 24) according to claim 1 and a stator.

13. A method for producing a rotor (10, 24) for an electric motor, in particular a brushless axial flux motor or a brushless radial flux motor, magnets (22, 31) of the rotor being attached to a rotor body of the rotor, comprising attaching at least two rotor elements (12, 26, 40, 41, 42, 43) of the rotor body to at least one rotor hub (17, 33, 34) of the rotor body for being coupled to a motor shaft of the electric motor, the rotor elements forming struts (13, 14, 27, 28, 45, 46, 48, 49) extending from the rotor hub in the shape of a star in a radial direction of the rotor, the rotor elements being made of a fiber composite material, the magnets being attached to the rotor elements.

14. The method according to claim 13, wherein the rotor elements (12, 26, 40, 41, 42, 43) are formed by forming a hollow winding profile (11, 25) by impregnating and winding a fiber material or by winding a semi-finished fiber matrix product onto a circumference of a winding core and cutting the winding profile into the rotor elements.

15. The method according to claim 14, wherein the winding profile (11, 25) is removed from the winding core prior to cutting.

16. The method according to claim 13, wherein the rotor elements (12, 26, 40, 41, 42, 43) are form-fitted or force-fitted or bonded to the rotor hub (17, 33, 34).

17. The method according to claim 13, wherein the rotor elements (12, 26, 40, 41, 42, 43) are form-fitted or force-fitted or bonded to each other.

18. The method according to claim 13, wherein the magnets (22, 31) are form-fitted or force-fitted or bonded to the rotor elements (12, 26, 40, 41, 42, 43).

19. The method according to any one of claim 13, wherein a circumferential reinforcement (21, 39) of the rotor body is attached to the rotor elements (12, 26, 40, 41, 42, 43) in such a manner that the struts (13, 14, 27, 28, 45, 46, 48, 49) extend in the shape of a star between the rotor hub (17, 33, 34) and the reinforcement.

20. The method according to claim 13, wherein an outer ring of the rotor body is formed by winding on the rotor body or attached to the rotor body in such a manner that the struts (13, 14, 27, 28, 45, 46, 48, 49) extend in the shape of a star between the rotor hub (17, 33, 34) and the outer ring.
